(19) United States
(12) Patent Application Publication
(10) Pub. No.: US 2018/0338555 A1
(43) Pub. Date: Nov. 29, 2018

(54) System and Method for Wearable Display

(71) Applicant: Bioworld Merchandising, Irving, TX (US)

(72) Inventor: Franz Crystal, Plano, TX (US)

(21) Appl. No.: 15/796,129

(22) Filed: Oct. 27, 2017

Related U.S. Application Data
(60) Provisional application No. 62/511,103, filed on May 25, 2017.

(51) Int. Cl. A42B 1/00; A42B 1/24; G09F 9/302

(52) U.S. Cl. CPC A42B 1/004; G09F 9/33; G09F 9/3023; A42B 1/248

(57) ABSTRACT

In an embodiment, an apparatus includes: a bill; a plurality of side panels; a front panel connected to the bill and the side panels, the front panel having an opening extending from an exterior of the front panel to an interior of the front panel; and a flexible display system attached to the interior of the front panel, a portion of the flexible display system being exposed by the opening.

### CROSS-REFERENCE TO RELATED APPLICATIONS

This application claims the benefit of U.S. Provisional Application No. 62/511,103, filed on May 25, 2017, which application is hereby incorporated herein by reference.

### BACKGROUND

Clothing and accessories, such as hats, backpacks, purses, brooches, and the like may be decorated with text or graphic, such as sports team logos. Wearers may prefer to personalize their clothing and accessories to make them more distinctive. Most clothing and accessories are decorated during manufacture, and so personalization is often performed by wearers post-manufacture.

### SUMMARY

In an embodiment, an apparatus includes: a bill; a plurality of side panels; a front panel connected to the bill and the side panels, the front panel having an opening extending from an exterior of the front panel to an interior of the front panel; and a flexible display system attached to the interior of the front panel, a portion of the flexible display system being exposed by the opening.

In some embodiments, the flexible display system includes: a display panel disposed behind the opening; a battery disposed adjacent the display panel; and a control board disposed adjacent the display panel. In some embodiments, the apparatus further includes a mounting frame including: a display panel frame, the display panel disposed in the display panel frame; a battery frame, the battery disposed in the battery frame; and a control board frame, the control board disposed in the control board frame. In some embodiments, the display panel frame, the battery frame, and the control board frame are adhered to the interior of the front panel. In some embodiments, the display panel frame include wire guides, the battery and the control board are connected by wires, and the wires are disposed in the wire guides. In some embodiments, the display panel frame include a notch, the display panel and the control board are connected by a flexible connector, and the flexible connector is disposed in the notch. In some embodiments, the flexible connector is a chip-on-flex connector. In some embodiments, the apparatus further includes: a bezel extending through the opening, the bezel surrounding the display panel, the bezel attached to the display panel frame. In some embodiments, a portion of the front panel is disposed between the bezel and the display panel. In some embodiments, the apparatus further includes a lens, the lens disposed in the opening on the display panel, the bezel and the display panel surrounding the lens.

In an embodiment, an apparatus includes: a wearable article; a mounting frame attached to the wearable article, the mounting frame including: a display panel frame; a battery frame adjacent the display panel frame; and a control board frame adjacent the display panel frame; and a flexible display system including: a display panel attached to the wearable article by the display panel frame; a battery attached to the wearable article by the battery frame; and a control board attached to the wearable article by the control board frame, the control board electrically connected to the battery and the display panel.

In some embodiments, the display panel, the battery, and the control board are formed on different substrates. In some embodiments, the display panel and the control board are electrically connected by a chip-on-flex connector. In some embodiments, the apparatus further includes: a lens disposed on the display panel; and a bezel attached to the display panel frame, the lens and the display panel disposed between the bezel and the display panel frame. In some embodiments, the wearable article has an opening, and the bezel extends through the opening. In some embodiments, the display panel frame and the battery frame are connected by first hinges, and the display panel frame and the control board frame are connected by second hinges. In some embodiments, the control board includes a charging circuit, and the flexible display system further includes: a magnetic connector connected to the charging circuit.

In an embodiment, a method includes: receiving, by a flexible display system attached to a wearable article, first media content from a remote device, the flexible display system and the remote device communicating over a personal area networking protocol; storing, by the flexible display system, the first media content on storage of the flexible display system; and displaying, by the flexible display system, the first media content on a display panel of the flexible display system.

In some embodiments, the method further includes: changing, by the flexible display system, the first media content on the display panel to a second media content in response to detecting a tap of the display panel. In some embodiments, detecting a tap of the display panel includes: receiving, by the flexible display system, a first signal from an accelerometer of the flexible display system, the first signal greater than a predetermined threshold.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 illustrates a hat, in accordance with some embodiments.

FIG. 2 illustrates the flexible display system, in accordance with some embodiments.

FIGS. 3A, 3B, and 3C illustrate mounting frames, in accordance with some embodiments.

FIGS. 4A and 4B illustrate a bezel, in accordance with some embodiments.

FIGS. 5A and 5B illustrate perspective views during a process for attaching a display panel frame and bezel, in accordance with some embodiments.

FIGS. 6A and 6B illustrate perspective views during a process for attaching a display panel frame and bezel, in accordance with some embodiments.

FIG. 7 is a block diagram of a flexible display system, in accordance with some embodiments.

FIG. 8 illustrates a method for displaying content on a hat, in accordance with some embodiments.

### DETAILED DESCRIPTION OF ILLUSTRATIVE EMBODIMENTS

The making and using of embodiments of this disclosure are discussed in detail below. It should be appreciated, however, that the concepts disclosed herein can be embodied in a wide variety of specific contexts, and that the specific embodiments discussed herein are merely illustrative and do not serve to limit the scope of the claims. Further, it should be understood that various changes, substitutions, and alterations can be made herein without departing from the spirit and scope of this disclosure as defined by the appended claims.

In accordance with some embodiments, a wearable article includes a bezel, which is used to attach a flexible display system to the wearable article. The flexible display system may include a display panel, which may be used to display image or text selected by a wearer of the article. Because images decorated on wearable articles are passive in nature, changing the image or text on the wearable article may require removal of the image or text and the application of a new image or text. By incorporating a display system on a wearable article, customizing the appearance of the wearable article may be accomplished post-manufacture in a simpler and quicker manner. Further, use of a flexible display system allows the display system to conform to the shape of the wearable article, and allows the additional weight of the display system to be more even distributed when the article is worn.

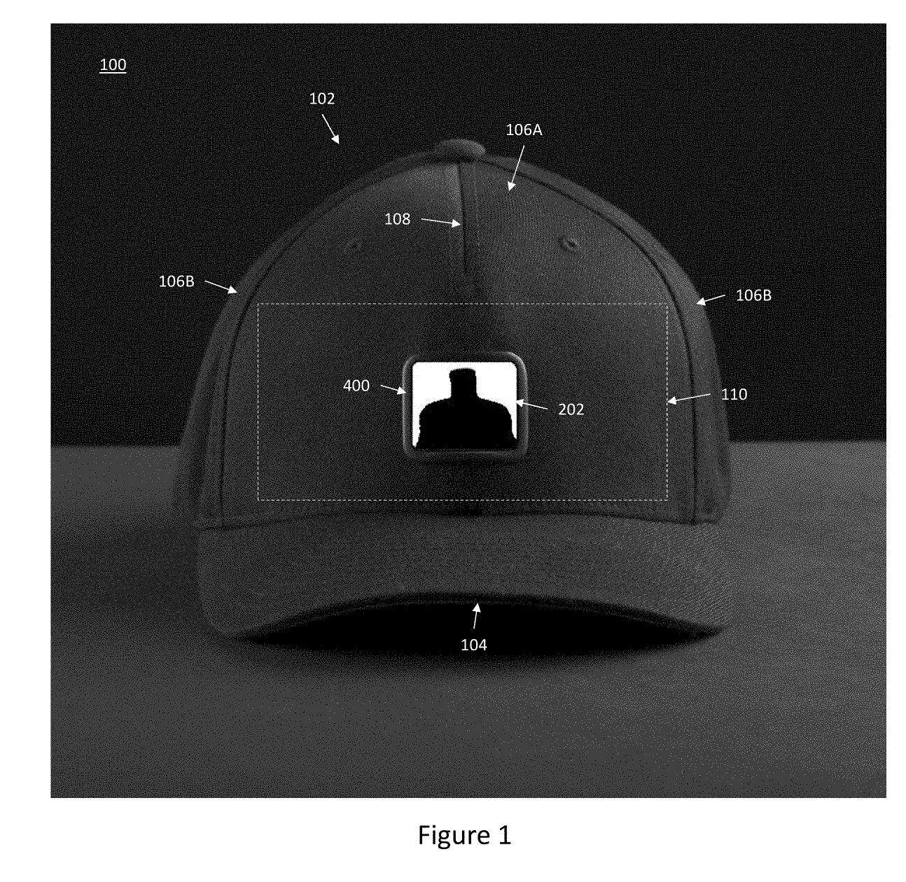

FIG. 1 illustrates a hat 100, in accordance with some embodiments. The hat 100 includes a crown 102 and a bill 104. The crown 102 is formed from a plurality of panels 106, which includes a front panel 106A and side panels 106B. The crown 102 also includes back panels (not shown), which are similar to the side panels 106B. The bill 104 is connected to the front panel 106A, and may be connected to portions of some of the side panels 106B. Each of the panels 106 is joined by a seam 108. The side panels 106B form portions of the crown 102 that extend around the sides and back of a wearer's head. The front panel 106A extends along the wearer's forehead. The front panel 106A is larger than the side panels 106B. A partial seam 108 extends through a top portion of the front panel 106A such that the top portion of the front panel 106A is curved and remaining portions of the front panel 106A have a portion no that is substantially free from the seams 108.

A bezel 400 attaches a flexible display system 200 (discussed below) to the portion no of the crown 102. Because the flexible display system 200 is flexible, it may be distributed across the portion no of the crown 102 such that the various pieces of the flexible display system 200 substantially conform to the curvature of the hat 100. For example, the components of the flexible display system 200 may be disposed in different planes, e.g., not in a common plane. The flexible display system 200 includes a display panel 202, and may communicate with a remote device (e.g., a wearer's smart phone or other electronic device) and display desired media content (e.g., an image, a video, moving text, etc.) selected by the remote device. For example, the display panel 202 may be used to display a variety of image formats, such as a joint photographic experts group (JPG) image, a portable network graphics (PNG) image, a graphics interchange format (GIF) image, or the like. The image may be static or in motion, for example, in embodiments where a GIF image is displayed.

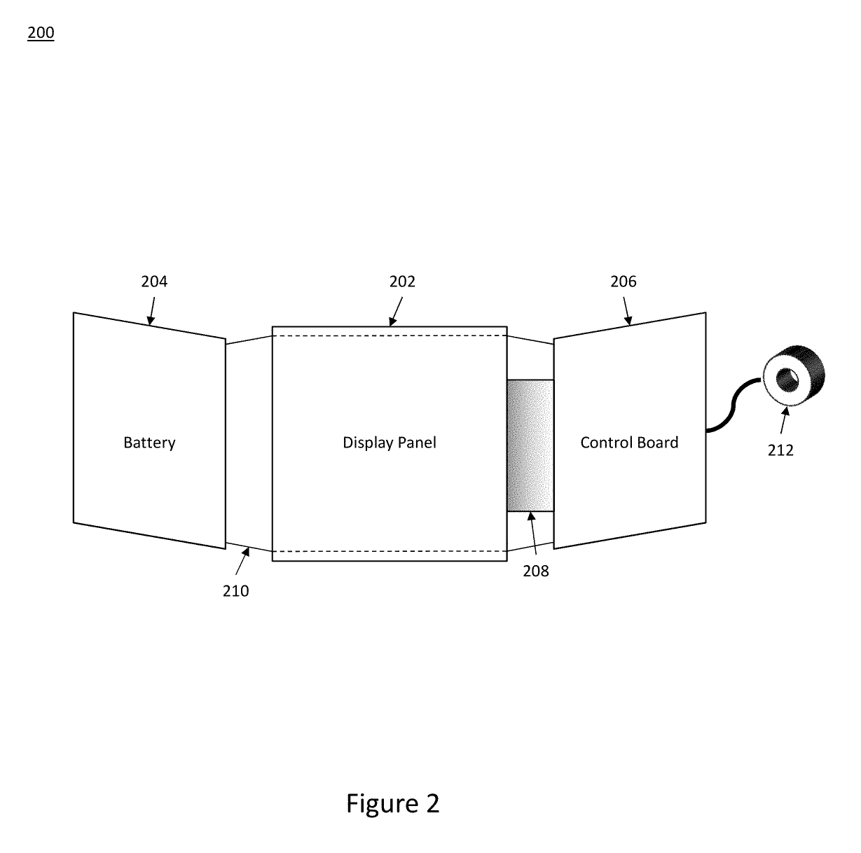

FIG. 2 illustrates the flexible display system 200, in accordance with some embodiments. The flexible display system 200 is referred to as being “flexible” because the components of the flexible display system 200 are not mounted to a common substrate, e.g., the components are formed on different substrates. Rather, the components of the flexible display system 200 are electrically and physically connected by flexible wires, but are free to move about within constraints of the connecting wires. Free movement of the components allows the flexible display system 200 to substantially conform to the crown 102. The flexible display system 200 includes the display panel 202, a battery 204, and a control board 206. As a result of the flexibility, the display panel 202 may be centered and mounted to the front panel 106A of the hat wo, with the controller board 206 and battery 204 distributed to each side for even weight distribution, which may increase comfort of the wearer.

The display panel 202 may be full-color panel, such as a liquid crystal display (LCD) panel, a light-emitting diode (LED) display panel, an organic LED (OLED) display panel, a plasma display panel (PDP), thin-film-transistor (TFT) LCD, an E-Ink display panel, or the like. Although the display panel 202 may be any size, in an embodiment, the display panel 202 is a 1.8-inch square panel, which allows the display panel 202 to be sufficiently visible without sacrificing portability. In such embodiments, the 1.8-inch display panel 202 may be a thin-film-transistor (TFT) LCD with a resolution of 256×256 pixels and a color depth of 18 bits.

The battery 204 is a rechargeable battery, such as a lithium-ion (Li-ion) battery. The battery 204 is a power source for the components of the flexible display system 200. In some embodiments, the battery 204 has sufficient capacity to provide charge up to for a full day or more of wearing the hat 100, such as from about 8 hours to about 10 hours. In an embodiment, the battery 204 is a 3.7 V rechargeable lithium polymer battery.

The control board 206 provides content for the display panel 202. As discussed further below, the control board 206 may communicate with a remote device (e.g., a wearer's smart phone) to receive content. The content is stored on the control board 206 and displayed on the display panel 202. Further, content shown on the display panel 202 may be interchangeable with other content stored in memory by tapping the display panel 202.

A connector 208 electrically connects the display panel 202 to the control board 206. The connector is a parallel interface, and in an embodiment, is a chip-on-flex (COF) device. The connector 208 includes the display driver for the display panel 202, allowing the display driver to not be mounted on the display panel 202. Locating the display driver in a COF connector 208 may lessen the amount of dead space on the display panel 202, increasing the viewable display space.

Battery wires 210 electrically connect the battery 204 to the control board 206. The battery wires 210 are routed around the display panel 202, such that they are not visible. The control board 206 controls charging of the battery 204. An external connector 212 allows the control board 206 to be connected to a charging power source. In an embodiment, the external connector 212 is a magnetic connection, which provides some water resistance. Notably, a water resistant external connector 212 reduces the probability that the external connector 212 will short due to perspiration of the wearer or moisture in the environment. In some embodiments, the external connector 212 extends through a panel of the crown 102 such that it is exposed along the exterior of the crown 102. In some embodiments, the external connector 212 is stored within trim of the crown 102.

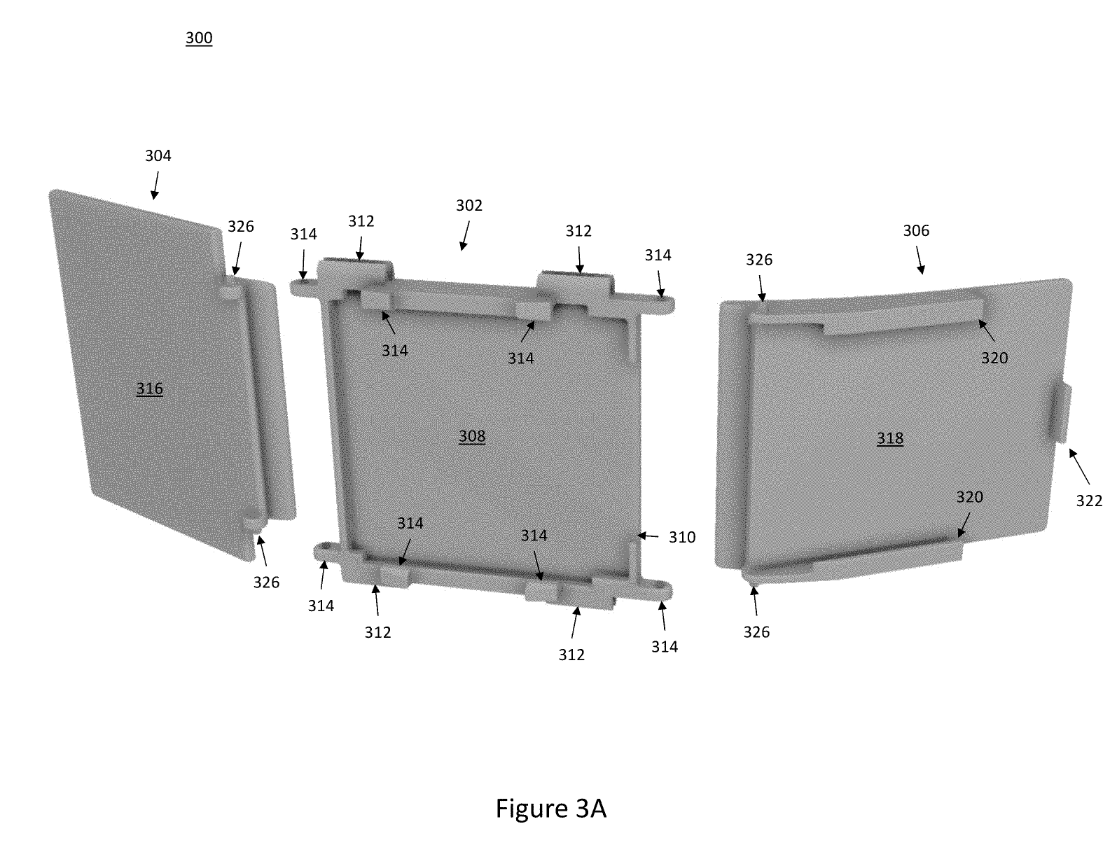

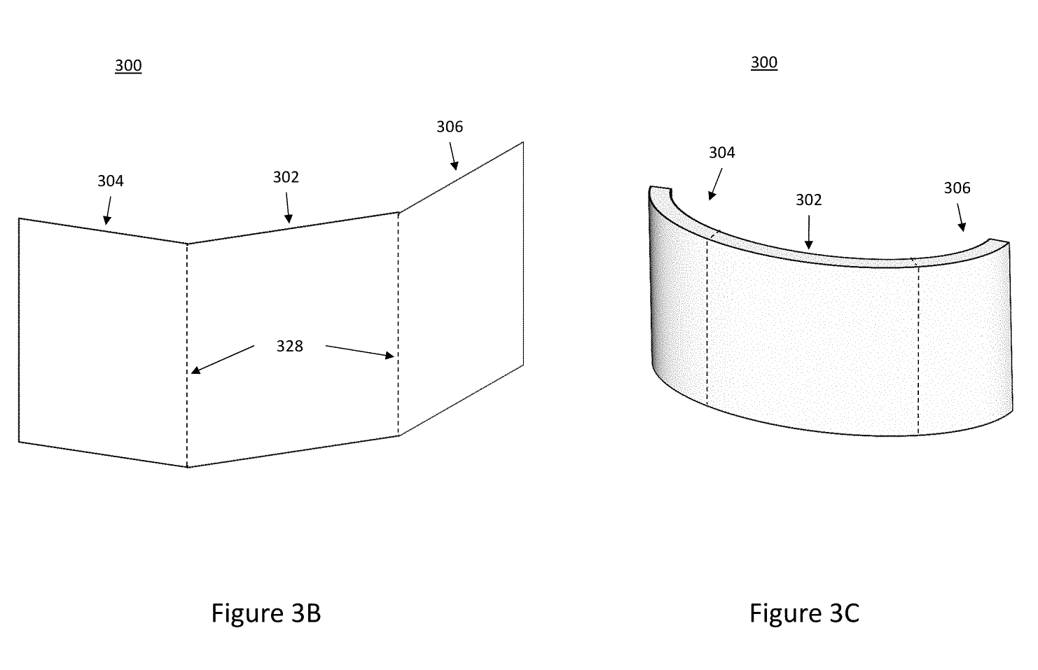

FIG. 3A illustrates a mounting frame 300, in accordance with some embodiments. The mounting frame 300 houses the flexible display system 200, and includes a plurality of panels that hold the components of the flexible display system 200. In particular, the mounting frame 300 includes a display panel frame 302, a battery frame 304, and a control board frame 306. The panels are formed from a non-metallic or insulating material, which provides rigidity and reduces radio frequency (RF) interference with wireless networking functions of the control board 206. For example, the panels may be formed from plastic. After assembly, the mounting frame 300 is attached to the front panel 106A of the hat 100 by the bezel 400 (discussed below). Because the panels of the mounting frame 300 are moveable, the mounting frame 300 conforms to the shape of the crown 102 when mounted on the back of the portion 110.

The display panel frame 302 includes a tray 308. The display panel 202 is mounted in the tray 308, and the back side of the display panel 202 is adhered to the tray 308. A notch 310 on the side of the tray 308 accommodates the COF connector 208. Wire guides 312 on the top and bottom of the tray 308 accommodate the battery wires 210. Bezel clips 314 on the top and bottom of the tray 308 provide a mounting point for the bezel 400. Although shown as being flat, the display panel frame 302 may be contoured in some embodiments, to conform to any curves in the front panel 106A.

The battery frame 304 includes a flat portion 316. The battery 204 is adhered to the flat portion 316 with, e.g., tape, glue, brackets, clips or the like.

The control board frame 306 includes a flat portion 318, guide rails 320, and a stabilizing portion 322. The controller board 206 is secured to the flat portion 318 by the guide rails 320. In particular, the controller board 206 is slid into the guide rails 320 until it is bordered by the guide rails 320 and stabilizing portion 322.

Hinges connect the display panel frame 302 to the battery frame 304 and control board frame 306. Ear portions 324 of the hinges are affixed to both sides of the display panel frame 302, adjacent the wire guides 312. Pin portions 326 of the hinges are affixed to sides of the battery frame 304 and control board frame 306. During assembly, the pin portions 326 are inserted into respective ear portions 324, thereby coupling the battery frame 304 and control board frame 306 to the display panel frame 302.

FIGS. 3B and 3C illustrate the mounting frame 300, in accordance with some other embodiments. In the embodiments shown in FIGS. 3B and 3C, the mounting frame 300 is molded from a single, continuous material, such as plastic. In the embodiment shown in FIG. 3B, the panels of the mounting frame 300 are each planar, and are connected by seams 328. The seams 328 may be, e.g., portions of plastic that are thinner than the plastic forming the panels. In the embodiment shown in FIG. 3C, the mounting frame 300 is a single panel that is curved to conform to the shape of the crown 102. The components of the flexible display system 200 are attached to different regions of the curved mounting frame 300.

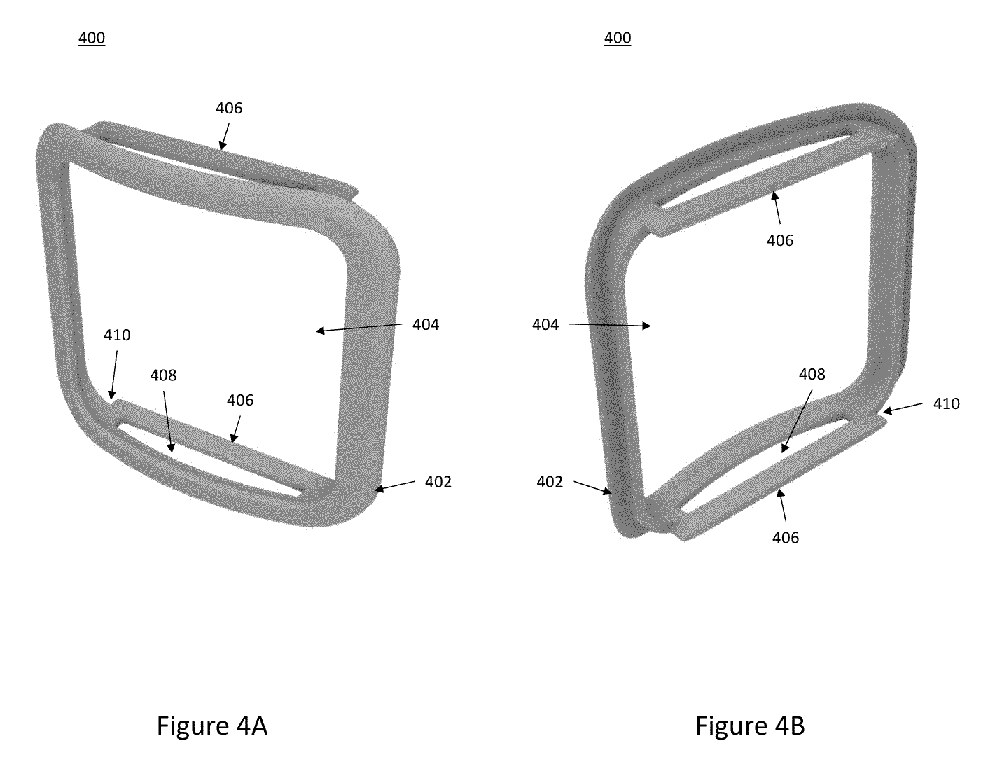

FIGS. 4A and 4B illustrate the bezel 400, in accordance with some embodiments. FIG. 4A shows the front of the bezel 400, and FIG. 4B shows the back of the bezel 400. The bezel 400 surrounds and protects the display panel 202, and is used to attach the mounting frame 300 to the crown 102. The bezel 400 includes a protective perimeter 402 and loops 406. The protective perimeter 402 defines an opening 404, through which the display panel 202 will be visible. The loops 406 are formed on the back of the perimeter 402. The loops 406 are receptacles for the bezel clips 314 of the display panel frame 302, and define openings 408. When attaching the display panel frame 302 to the bezel 400, the bezel clips 314 slide over the loops 406 and are secured in the openings 408. Notches 410 are at the interface of the perimeter 402 and loops 406.

The bezel 400 is formed from a non-metallic or insulating material, which provides rigidity and reduces radio frequency (RF) interference with wireless networking functions of the control board 206. For example, the bezel 400 may be formed from plastic. The bezel 400 may be cast from a single mold such that the perimeter 402 and loops 406 are a single, continuous material.

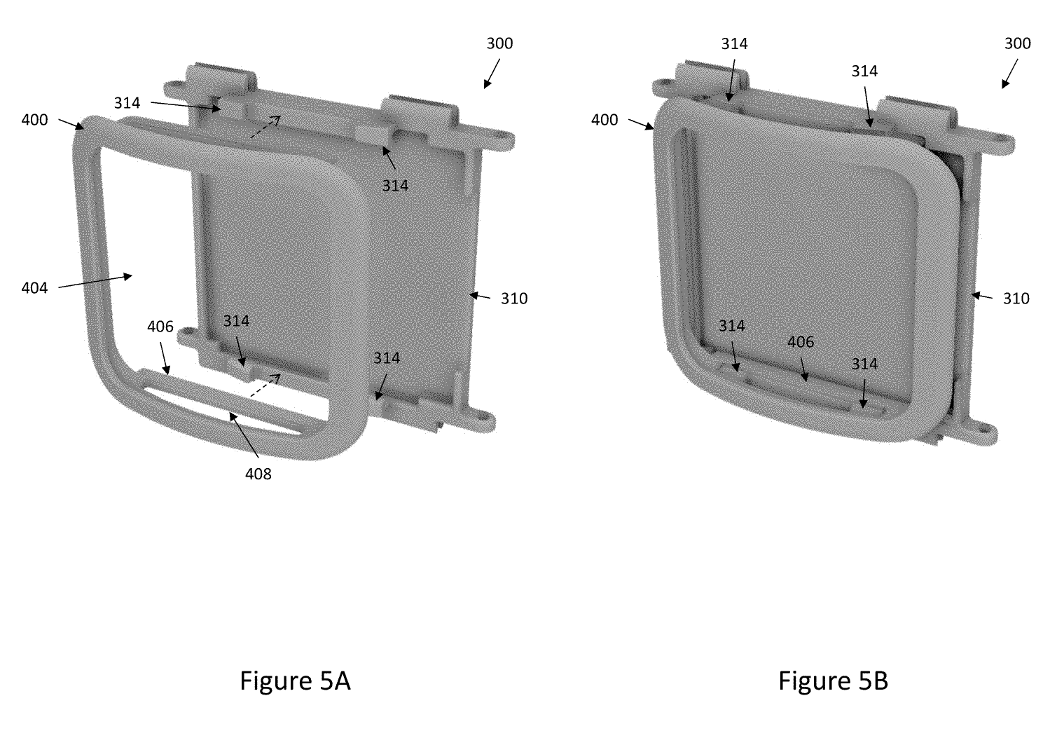

FIGS. 5A and 5B illustrate perspective views during a process for attaching the display panel frame 302 and bezel 400, in accordance with some embodiments. When attaching the display panel frame 302 and bezel 400, the bezel clips 314 of the display panel frame 302 are aligned with the loops 406 of the bezel 400. The bezel 400 is pushed onto the display panel frame 302 such that the bezel clips 314 slide over the loops 406 and are secured in the openings 408. After securing attaching the display panel frame 302 to the bezel 400, a chamber is formed, with the notch 310 and openings 404, 408 being outlets of the chamber.

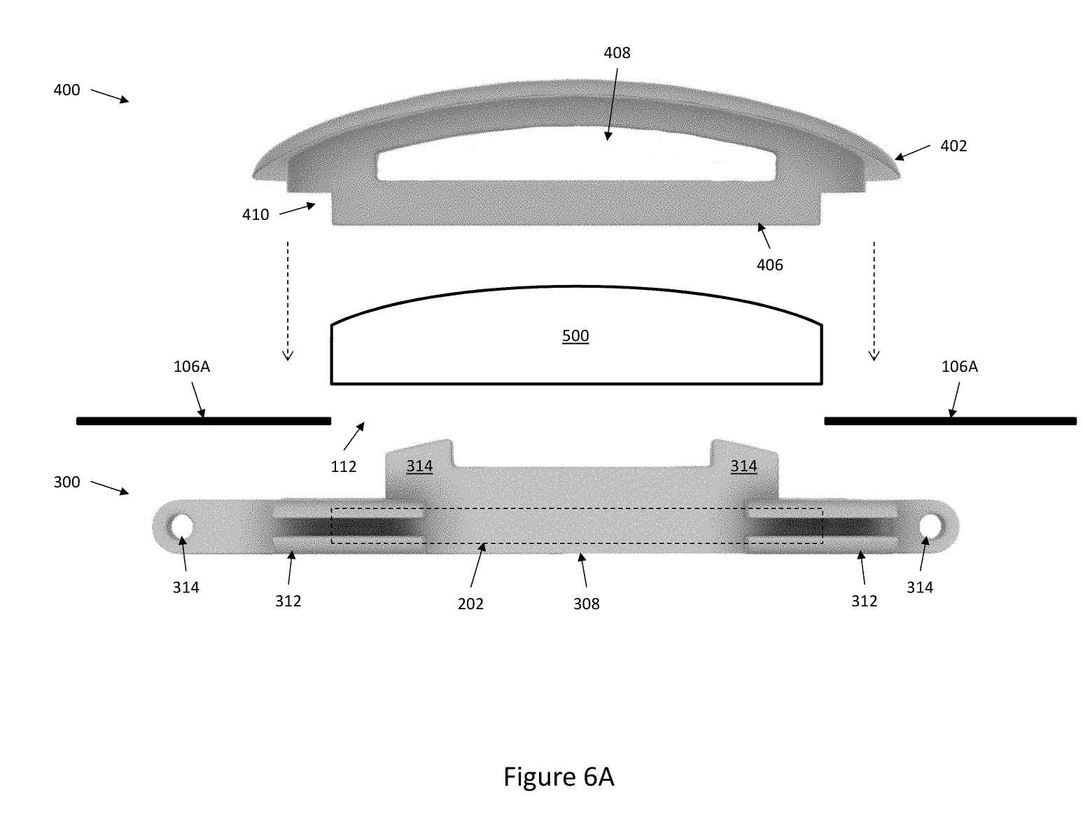

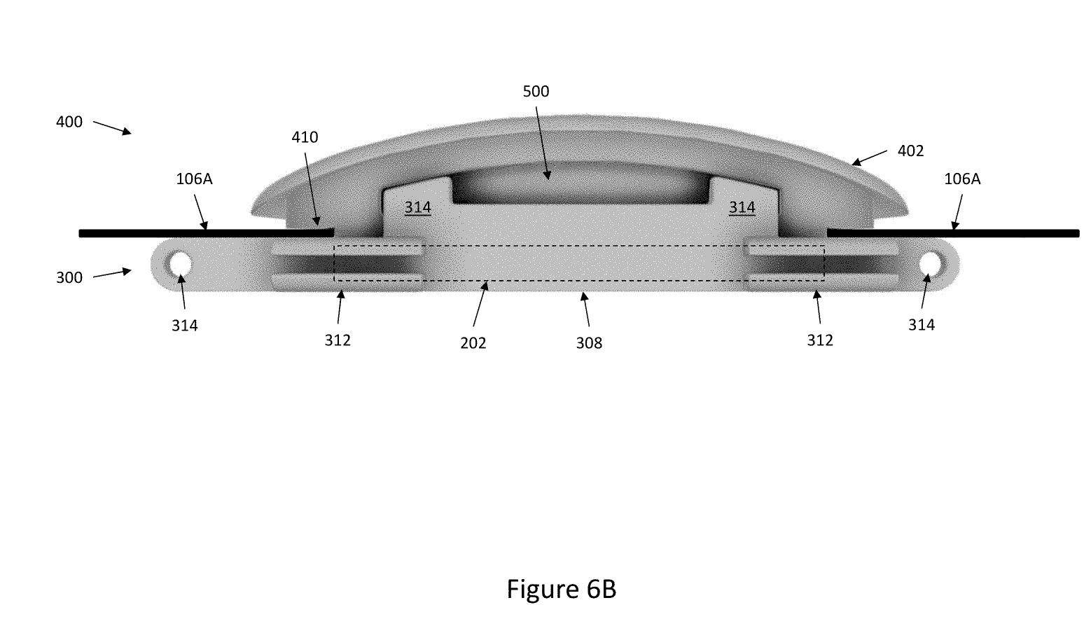

FIGS. 6A and 6B illustrate perspective views during a process for attaching the display panel frame 302 and bezel 400 to the crown 102, in accordance with some embodiments. When attaching the display panel frame 302 and bezel 400, an opening 112 is formed in the front panel 106A of the crown 102. The display panel 202 is placed in the tray 308.

The display panel frame 302 is positioned on the interior of the front panel 106A, and the bezel 400 is positioned on the exterior of the front panel 106A. The display panel frame 302 is aligned with the opening 112 such that the bezel clips 314 will extend through the opening 112, and the bezel 400 is aligned with the opening 112 such that the notches 410 will border sides of the openings 112. As such, after assembly, a portion of the flexible display system 200 will be exposed by the opening 112. The display panel frame 302 and bezel 400 are pressed together such that the bezel clips 314 are secured in the openings 408. A lens 500 is disposed in the chamber formed by the display panel frame 302 and bezel 400. The lens 500 is formed from polished acrylic, and increases the viewing angle of the display panel 202. The notches 410 allow portions of the front panel 106A to be sandwiched between the display panel frame 302 and bezel 400, securing them in place. In some embodiments, an adhesive is used to adhere the display panel frame 302 to the interior of the front panel 106A. The adhesive may be tape, glue, or the like.

The battery frame 304 and control board frame 306 may be attached to the display panel frame 302. As such, the mounting frame 300 is secured to the hat. The display panel frame 302, battery frame 304, and control board frame 306, respectively, hold the display panel 202, battery 204, and control board 206. In some embodiments, an adhesive is used to adhere the battery frame 304 and control board from 306 to the interior of the front panel 106A. The adhesive may be tape, glue, or the like. In some embodiments, the mounting frame 300 may be placed in a pocket, liner, r pouch along the interior of the front panel 106A. The components of the flexible display system 200 may be disposed in their respective frames before or after attaching the mounting frame 300 to the crown 102.

Because the portion 110 of the crown substantially free from seams 108, the mounting frame 300 may avoid the seams 108 when installed in the crown 102. This may avoid repetitive bending of the flexible connector 208, increasing reliability of the flexible display system 200.

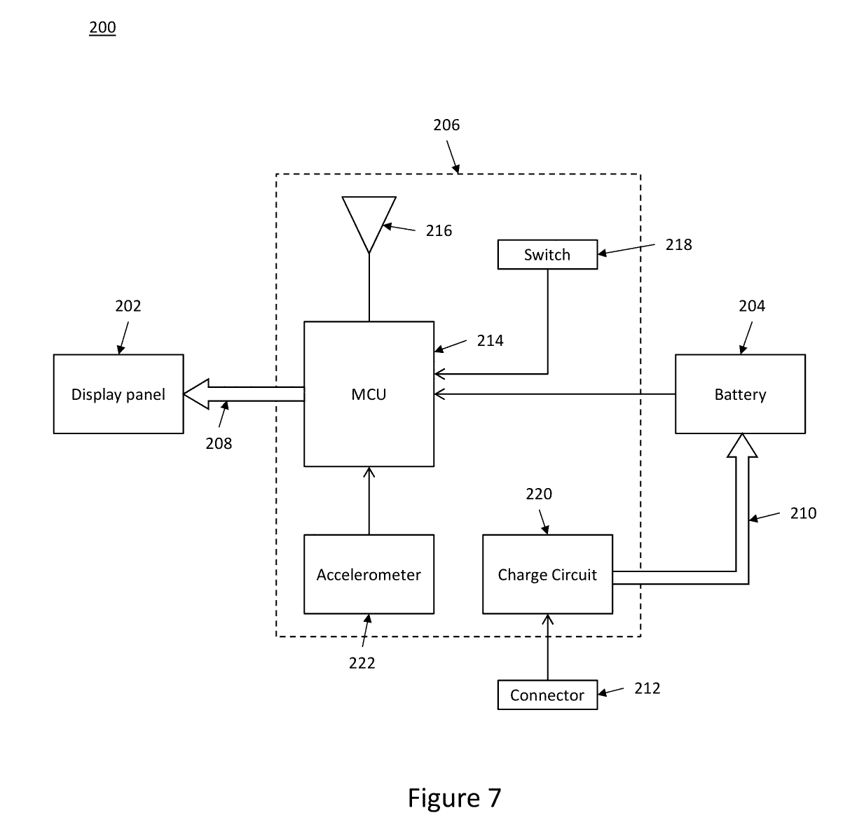

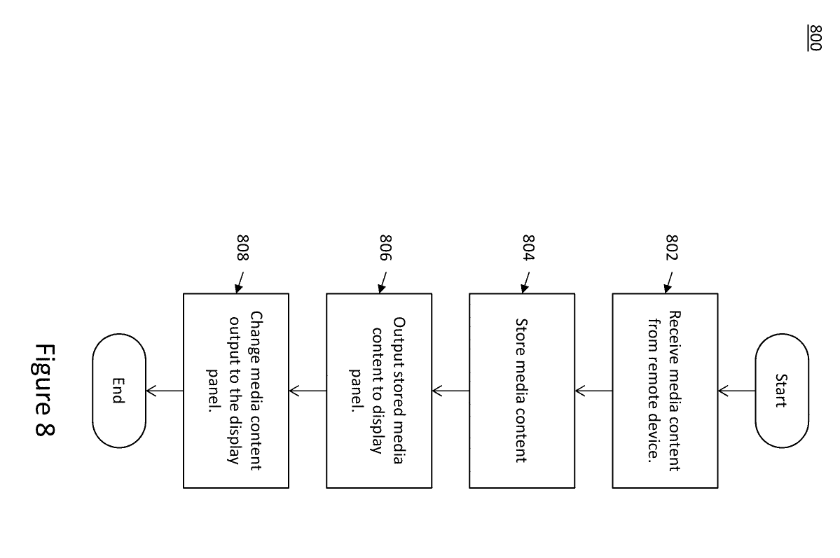

FIG. 7 is a block diagram of the flexible display system 200, in accordance with some embodiments. In particular, more details of the control board 206 are shown. The control board 206 may be used to communicate with a remote device (e.g., a wearer's smart phone or other electronic device) and display desired media content (e.g., an image, a video, moving text, etc.) selected by the remote device. For example, media content obtained via social sharing may be downloaded by an application on a smart phone and transmitted to the control board 206 for display on the display panel 202. Likewise, content may be transmitted to the control board 206 from the internal camera of the smart phone, or from an image library on the smart phone. The control board 206 comprises a master control unit (MCU) 214, antennas 216, a switch 218, charge circuit 220, and an accelerometer 222.

The MCU 214 controls the components of the flexible display system 200, communicates with remote devices, stores content, and displays content on the display panel 202. The MCU 214 may be, e.g., a microcontroller that includes processing functionality, storage functionality, and networking functionality. For example, the MCU 214 may be a device based on an ARM Cortex Mo, such as a Nordic NRF52840 system-on-chip (SoC).

The networking functionality of the MCU 214 may support short-range personal area networks (PANs), such as Bluetooth. The networking functionality may use a protocol with reduced power consumption, such as Bluetooth Low Energy (BLE). The baseband controller, radio, and antennas 216 for the networking functionality may be built in to the MCU 214, e.g., on a same substrate. The networking functionality is used by the MCU 214 to connect to a remote device, and receive media content. For example, the media content may be sent to the MCU 214 with Bluetooth using the object exchange (OBEX) protocol.

The MCU 214 may have volatile or non-volatile storage, such as non-volatile memory (NVRAM), flash memory, or the like, for storing the content to display on the display panel 202. For example, content received from the remote device may be stored in the storage of the MCU 214. The storage may also hold configuration data, firmware or software executed by the MCU 214, and the like.

The MCU 214 also performs input/output (I/O). In particular, the MCU 214 includes I/O functionality for outputting content to the display panel 202, for receiving power from the battery 204, and for interacting with sensors and switches. In an embodiment, the MCU 214 communicates with the display panel 202 (via the connector 208) using the Serial Peripheral Interface (SPI) protocol. In some embodiments, the MCU 214 communicates with the switch 218 using a programmed input/output (PIO) interface.

The processing functionality of the MCU 214 may be used for processing or manipulating the content output to the display panel 202. As noted above, the display panel 202 may have a particular resolution and color depth. The MCU 214 may be configured to resize content for the display panel 202 before it is output to the display panel 202 (e.g., via SPI). Likewise, the MCU 214 may resample the color depth of content to be compatible with the supported color depth of the display panel 202.

The switch 218 may interact with the MCU 214 via the I/O functionality of the MCU 214. The switch 218 may be used for initiating pairing of the MCU 214 with the remote device (e.g., via Bluetooth), powering the flexible display system 200 on and off, and resetting the flexible display system 200.

The charge circuit 220 controls charging of the battery 204, and is electrically connected to the external connector 212. In some embodiments, the MCU 214 performs power management for the battery 204 to extend the charge life of the battery 204. For example, the MCU 214 may adjust brightness of the display panel 202 or instruct the various component of the flexible display system 200 to enter a low-power (e.g., sleep) mode.

The accelerometer 222 allows the MCU 214 to provide motion sensing functionality. The MCU 214 receives sensor signals from the accelerometer 222, and may change the content displayed on the display panel 202 in response to the sensor signals. For example, the accelerometer 222 may be used to detect a tap of the display panel 202 by the wearer. The MCU 214 is configured to change the content displayed on the display panel 202 upon detection of a tap. The MCU 214 may cycle through the content stored on the storage, and display queued content mage in response to each tap.

FIG. 8 illustrates a method 800 for displaying content on the hat 100, in accordance with some embodiments. As noted above, the flexible display system 200 of the hat wo communicates with a remote device (e.g., a wearer's smart phone or other electronic device) over a networking technology such as Bluetooth. The flexible display system 200 receives media content from the remote devices, stores the media content using the storage of the MCU 214, and outputs the stored media content to the display panel 202.

The flexible display system 200 receives the media content from the remote device (step 802). The remote device may be, e.g., a smart phone such as an Apple iPhone or an Android-based phone. The remote device may obtain the media content from a variety of sources. For example, an application on the remote device may access a back-end service that serves the media content to the remote device. The remote device then transmits the content to the MCU 214 using, e.g., Bluetooth. The flexible display system 200 stores the media content (step 804). The flexible display system 200 outputs stored media content to the display panel 202 (step 806). Optionally, the flexible display system 200 changes the media content output to the display panel 202 (step 808). The change may be in response to signals from the accelerometer 222 exceeding a predetermined threshold stored on the MCU 214.

Although some embodiments have been described in the context of a hat 100, it should be appreciated that embodiments could be applied in any wearable article. For example, the wearable article could be a backpack, purse, brooch, or the like. The mounting frame 300 may be mounted through an opening on any wearable article, thereby attaching the flexible display system 200 to the wearable article.

Embodiments may achieve advantages. Because the mounting frame 300 includes multiple components, it allows the flexible display system 200 to conform to the shape of the hat 100, and allows the additional weight of the display system to be more even distributed when the article is worn. Comfort of the wearer may thereby be increased.

Although this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. An apparatus comprising:
a bill;
a plurality of side panels;
a front panel connected to the bill and the side panels, the front panel having an opening extending from an exterior of the front panel to an interior of the front panel; and
a flexible display system attached to the interior of the front panel, a portion of the flexible display system being exposed by the opening.

2. The apparatus of claim 1, wherein the flexible display system comprises:
a display panel disposed behind the opening;
a battery disposed adjacent the display panel; and
a control board disposed adjacent the display panel.

3. The apparatus of claim 2, further comprising a mounting frame comprising:
a display panel frame, the display panel disposed in the display panel frame;
a battery frame, the battery disposed in the battery frame; and
a control board frame, the control board disposed in the control board frame.

4. The apparatus of claim 3, wherein the display panel frame, the battery frame, and the control board frame are adhered to the interior of the front panel.

5. The apparatus of claim 3, wherein the display panel frame comprise wire guides, the battery and the control board are connected by wires, and the wires are disposed in the wire guides.

6. The apparatus of claim 3, wherein the display panel frame comprise a notch, the display panel and the control board are connected by a flexible connector, and the flexible connector is disposed in the notch.

7. The apparatus of claim 6, wherein the flexible connector is a chip-on-flex connector.

8. The apparatus of claim 3, further comprising:
a bezel extending through the opening, the bezel surrounding the display panel, the bezel attached to the display panel frame.

9. The apparatus of claim 8, wherein a portion of the front panel is disposed between the bezel and the display panel.

10. The apparatus of claim 8, further comprising a lens, the lens disposed in the opening on the display panel, the bezel and the display panel surrounding the lens.

11. An apparatus comprising:
a wearable article;
a mounting frame attached to the wearable article, the mounting frame comprising:
a display panel frame;
a battery frame adjacent the display panel frame; and
a control board frame adjacent the display panel frame; and
a flexible display system comprising:
a display panel attached to the wearable article by the display panel frame;
a battery attached to the wearable article by the battery frame; and
a control board attached to the wearable article by the control board frame, the control board electrically connected to the battery and the display panel.

12. The apparatus of claim ii, wherein the display panel, the battery, and the control board are formed on different substrates.

13. The apparatus of claim ii, wherein the display panel and the control board are electrically connected by a chip-on-flex connector.

14. The apparatus of claim ii, further comprising:
a lens disposed on the display panel; and
a bezel attached to the display panel frame, the lens and the display panel disposed between the bezel and the display panel frame.

15. The apparatus of claim 14, wherein the wearable article has an opening, and the bezel extends through the opening.

16. The apparatus of claim ii, wherein the display panel frame and the battery frame are connected by first hinges, and the display panel frame and the control board frame are connected by second hinges.

17. The apparatus of claim ii, wherein the control board comprises a charging circuit, and the flexible display system further comprises:
a magnetic connector connected to the charging circuit.

18. A method comprising:
receiving, by a flexible display system attached to a wearable article, first media content from a remote device, the flexible display system and the remote device communicating over a personal area networking protocol;
storing, by the flexible display system, the first media content on storage of the flexible display system; and
displaying, by the flexible display system, the first media content on a display panel of the flexible display system.

19. The method of claim 18, further comprising:
changing, by the flexible display system, the first media content on the display panel to a second media content in response to detecting a tap of the display panel.

20. The method of claim 19, wherein detecting a tap of the display panel comprises:
receiving, by the flexible display system, a first signal from an accelerometer of the flexible display system, the first signal greater than a predetermined threshold.
